(19) United States
(12) Patent Application Publication
(10) Pub. No.: US 2012/0043843 A1
(43) Pub. Date: Feb. 23, 2012

(54) MOTOR ROTOR AND MOTOR HAVING THE MOTOR ROTOR

(75) Inventors: Yung-Sheng Wu, Taipei (TW); Hung-Sen Tu, Taipei (TW); I-Hsing Chen, Taipei (TW)

(73) Assignee: SYSTEM GENERAL CORPORATION, Taipei (TW)

(21) Appl. No.: 12/859,756

(22) Filed: Aug. 19, 2010

(51) Int. Cl. H02K 1/28

(52) U.S. Cl. 310/156.12

(57) ABSTRACT

A motor rotor includes an annular body and a positioning protrusion installed on an inner lateral surface of the annular body. A magnetic body may be positioned by propping its lateral surface against the positioning protrusion, without the use of additional jigs. Therefore, the time needed to assemble the magnetic body to the annular body is saved, and the manufacturing cost of the whole motor is reduced.

### BACKGROUND OF THE INVENTION

1. Field of the Invention

This invention relates to motor rotors, and particularly, to a motor rotor with simplified manufacturing process and reduced cost.

2. Description of Related Art

In modern society, motors have been applied to a variety of products. In general, a motor forms an inductive magnetic field by using currents. The inductive magnetic field interacts with an inner permanent magnet to generate a rotational movement. In addition to providing the rotational movement, the motor may also output rotational mechanical energy that may be converted into a linear movement or vibrating movement by certain mechanisms.

Please refer to FIG. 1 (PRIOR ART), which is an oblique view of an outer rotor motor according to the prior art. The outer rotor motor comprises a stator 11 installed in a central region and a rotor 12 surrounding an outer periphery of the stator 11. The stator 11 is a stationary part. The stator 11 comprises a field coil 111, and generates a magnetic field by inputting currents into the field coil 111. The rotor 12 includes an annular body 121 and a plurality of permanent magnets 122 installed on an inner lateral surface of the annular body 121. The permanent magnet 122 provides another magnetic field. The rotor 12 generates a rotational movement according to an interaction of the two magnetic fields.

In manufacturing the rotor 12 of the outer rotor motor, the permanent magnets 122 have to be fastened to certain places of the inner lateral surface of the annular body 121 of the rotor 12. According to the prior art, an adhesive is applied on a back surface of the permanent magnets 122, and then the permanent magnets 122 are positioned and adhered to the inner lateral surface of the annular body 121 by using clamps or jigs. The clamps or jigs cannot be removed unless the adhesive is cured.

However, different motors have their own dedicated clamps or jigs, which increases the whole manufacturing cost of the motors. Moreover, the manufacturing process of using clamps or jig to position permanent magnets is complicated, and consumes much time.

Therefore, how to solve the drawbacks of the prior art to simplify the manufacturing process of a motor and reduce the manufacturing cost is becoming one of the most urgent issues in the art.

### SUMMARY OF THE INVENTION

In view of the above-mentioned drawbacks of the prior art, the present invention provides a motor rotor that includes an annular body, a first positioning protrusion installed on an inner lateral surface of the annular body, and a magnetic body installed on the inner lateral surface of the annular body and propping against the first positioning protrusion.

The motor rotor of an embodiment according the present invention further includes a second positioning protrusion installed on the inner lateral surface of the annular body and having a second height different from a first height of the first positioning protrusion, wherein the magnetic body props against both the first positioning protrusion and the second positioning protrusion.

In the motor rotor of an embodiment according the present invention, the first positioning protrusion has a first propping surface, the second positioning protrusion has a second propping surface, and the magnetic body props against the first propping surface and the second propping surface.

In the motor rotor of an embodiment according the present invention, the first and second positioning protrusions are locked, riveted or adhered to the annular body or are formed by punching the annular body.

In the motor rotor of an embodiment according the present invention, the magnetic body may be fastened to the annular body by adhesive, in association with the first positioning protrusion and second positioning protrusion.

In the motor rotor of an embodiment according the present invention, the annular body is a sheet metal part.

In the motor rotor, the annular body includes non-magnetoconductive metal or plastic, and the non-magnetoconductive is one selected from the group consisting of aluminum, copper, zinc, tantalum and stainless steel.

In the motor rotor of an embodiment, the magnetic body may be a permanent magnet.

The present invention further provides a motor, comprising a stator and a rotor surrounding an outer periphery of the stator, the rotor comprising an annular body, a first positioning protrusion installed on an inner lateral surface of the annular body, and a magnetic body installed on the inner lateral surface of the annular body and propping against the first positioning protrusion.

In conclusion, the motor rotor of an embodiment has positioning protrusions installed on an inner lateral surface of an annular body for positioning magnetic bodies. Therefore, when the magnetic bodies are going to be installed on the annular body, they may be placed to the required positions easily, such that the time needed for a motor assembling is saved. Moreover, the positioning protrusions may be manufacturing by a punching technique. Compared with the prior art that uses clamps or jigs to position the magnetic bodies, the motor rotor of the present invention significantly reduces the whole cost of manufacturing a motor.

### BRIEF DESCRIPTION OF DRAWINGS

The present invention can be more fully understood by reading the following detailed description of the preferred embodiments, with reference made to the accompanying drawings, wherein:

FIG. 1 (PRIOR ART) is an oblique view of an outer rotor motor of the prior art;

FIG. 2A is an oblique view of a motor rotor according to an embodiment of the present invention; and

FIG. 2B is a top view of the motor rotor shown in FIG. 2A.

### DETAILED DESCRIPTION OF PREFERRED EMBODIMENTS

The following illustrative embodiments are provided to illustrate the disclosure of the present invention, these and other advantages and effects can be apparently understood by those in the art after reading the disclosure of this specification. The present invention can also be performed or applied by other different embodiments. The details of the specification may be on the basis of different points and applications, and numerous modifications and variations can be devised without departing from the spirit of the present invention.

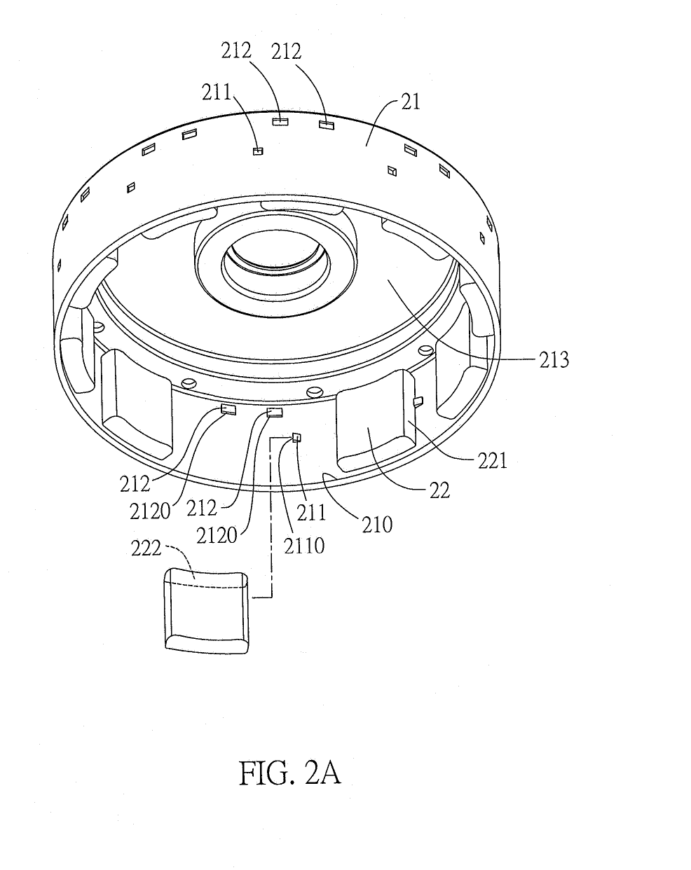

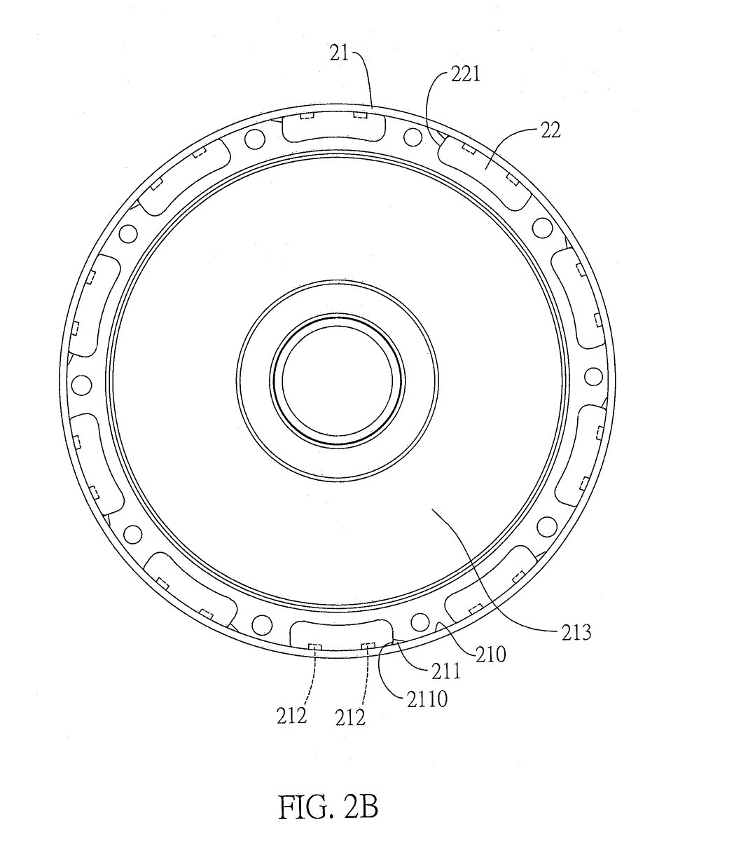

Please refer to FIGS. 2A and 2B, which are an oblique view and a top view of a motor rotor of an embodiment according to the present invention, respectively.

As shown in the figures, the motor rotor of the embodiment comprises an annular body 21; a plurality of first positioning protrusions 211 installed on an inner lateral surface 210 of the annular body 21; and a plurality of magnetic bodies 22 installed on the inner lateral surface 210 of the annular body, a lateral surface 221 of each of the magnetic bodies 22 propping against each of the first positioning protrusions 211.

Preferably, the motor rotor of the present invention further comprises a plurality of second positioning protrusion 212 installed on the inner lateral surface 210 of the annular body 21, allowing an end surface 222 of each of the magnetic bodies 22 to prop against each of the second positioning protrusions 212. Preferably, as shown in FIG. 2A the second positioning protrusions 212 have a second height different from a first height of the first positioning protrusions 211. In other words, the vertical distance (i.e. a first vertical distance) between the first positioning protrusions 211 and an inner bottom surface of the annular body 21 is different from that (i.e. a second vertical distance) between the second positioning protrusions 212 and the inner bottom surface 213 of the annular body 21. In the embodiment, the first vertical distance is greater than the second vertical distance.

Note that ten first positioning protrusions, twenty second positioning protrusions and ten magnetic bodies are exemplified in the embodiment. In practical applications, the motor rotor may have any number of first positioning protrusions, second positioning protrusions and magnetic bodies.

Preferably, each of the first positioning protrusions 211 of the motor rotor may have a first plane 2110 that acts as a first propping surface, allowing the lateral surface 221 of each of the magnetic bodies 22 to prop against the first plane 2110 correspondingly. Preferably, each of the second positioning protrusions 212 of the motor rotor may also have a second plane 2120 that acts as a second propping surface, allowing the end surface 222 of each of the magnetic body 22 to prop against the second plane 2120 correspondingly.

In the embodiment, each of the first positioning protrusions 211 or second positioning protrusions 212 may be locked, riveted or adhered to the annular bodies 21, or is formed by punching the annular bodies 21. Note that the first positioning protrusions 211 or second positioning protrusions 212 may be formed by other common techniques, which are not described here to avoid redundancy.

In the embodiment, the magnetic bodies 22 may be positioned by the first positioning protrusions 211 and/or second positioning protrusions 212, and may be securely fastened to the annular bodies 21 by adhesive (not shown).

In different embodiments, the annular bodies 21 may comprise sheet metal parts, non-magnetoconductive metal or plastic, and the non-magnetoconductive metal may be one selected from the group consisting of aluminum, copper, zinc, tantalum and stainless steel. The magnetic bodies 22 may be permanent magnets.

It may be known from FIGS. 2A and 2B that, since the first positioning protrusions 211 and/or the second positioning protrusions 212 are installed on the inner lateral surface 210 of the annular body 211, when the magnetic bodies 22 are going to be fastened to the inner lateral surface 210 of the annular body 21, the magnetic bodies 22 can be easily positioned to the required positions, without the use of any auxiliary tools (such as clamps or jigs). Therefore, the motor rotor of the embodiment according to the present invention is easy to be assembled, and the cost of manufacturing the positioning clamps and jigs is saved.

Further, the first positioning protrusions 211 and/or the second positioning protrusions 212 may be formed by punching the annular body 21 directly. Therefore, the formation of the first positioning protrusions 211 and the second positioning protrusions 212 do not increase too many manufacturing steps and manufacturing cost.

The motor rotor of the embodiment according to the present invention may be applied to a variety of motors, such as, but not limited to, a brushless DC motor (BLDC motor), permanent magnet synchronous motor (PMSM), or ceiling fan motor. A common stator may be installed in a central region. The stator is common knowledge in the art, further description hereby omitted.

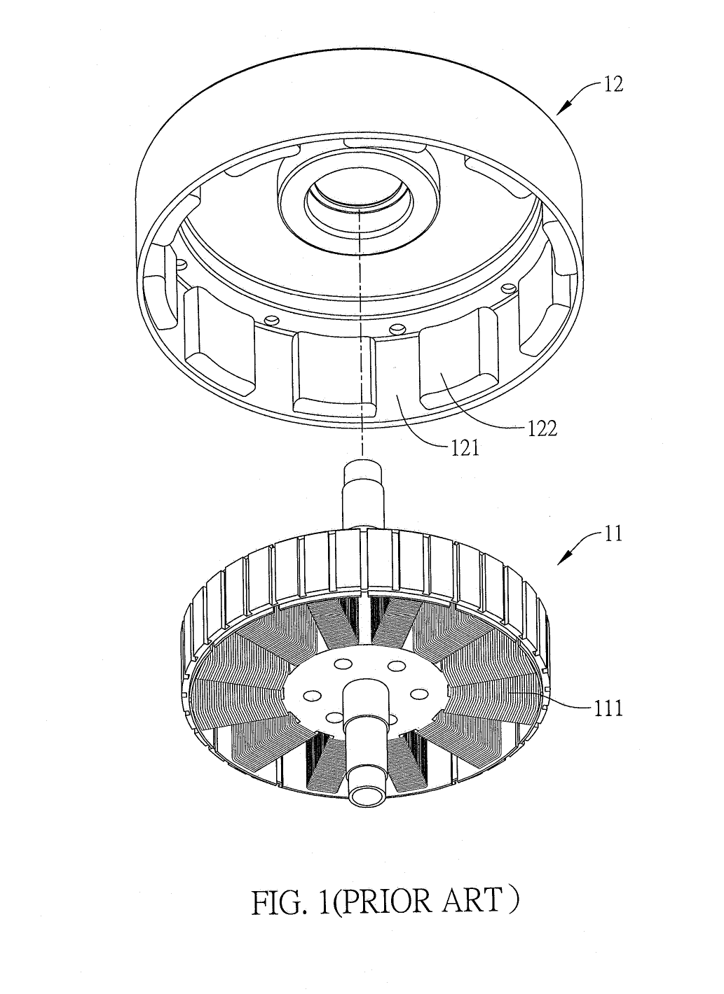

The present invention further provides a motor. The motor differs from the motor shown in FIG. 1 (PRIOR ART) in that the motor rotor shown in FIGS. 2A and 2B replaces the rotor shown in FIG. 1 (PRIOR ART). Accordingly, the motor of the present invention comprises the stator 11 and the motor rotor that surrounds an outer periphery of the stator 11 and comprises the annular body 21, the first positioning protrusion 211 installed on the inner lateral surface 210 of the annular body 21, and the magnetic body 22 installed on the inner lateral surface 211 of the annular body 21 and propping against the first positioning protrusion 211.

In conclusion, the motor rotor has positioning protrusions installed on an inner lateral surface of an annular body for positioning magnetic bodies. Therefore, when the magnetic bodies are going to be installed on the annular body, they may be placed to the required positions easily, such that the time needed for assemble a motor is saved. Moreover, the positioning protrusions may be manufacturing by a punching technique. Compared with the prior art that uses clamps or jigs to position the magnetic bodies, the motor rotor of the present invention reduces the whole cost of manufacturing a motor significantly.

The foregoing descriptions of the detailed embodiments are only illustrated to disclose the features and functions of the present invention and not restrictive of the scope of the present invention. It should be understood to those in the art that all modifications and variations according to the spirit and principle in the disclosure of the present invention should fall within the scope of the appended claims.

What is claimed is:

1. A motor rotor, comprising:
an annular body;
a first positioning protrusion installed on an inner lateral surface of the annular body; and
a magnetic body installed on the inner lateral surface of the annular body and propping against the first positioning protrusion.

2. The motor rotor of claim 1, wherein the first positioning protrusion has a first propping surface, and the magnetic body props against the first propping surface of the first positioning protrusion.

3. The motor rotor of claim 2, wherein the first propping surface is planar.

4. The motor rotor of claim 1, wherein first positioning protrusion is locked, riveted or adhered to the annular body or is formed by punching the annular body.

5. The motor rotor of claim 1, further comprising a second positioning protrusion installed on the inner lateral surface of the annular body and having a second height different from a first height of the first positioning protrusion, wherein the magnetic body props against the first positioning protrusion and the second positioning protrusion.

6. The motor rotor of claim 5, wherein the first positioning protrusion has a first propping surface, the second positioning protrusion has a second propping surface, and the magnetic body props against the first propping surface and the second propping surface.

7. The motor rotor of claim 6, wherein the first and second propping surfaces are planar.

8. The motor rotor of claim 5, wherein the first and second positioning protrusions are locked, riveted or adhered to the annular body or are formed by punching the annular body.

9. The motor rotor of claim 1, wherein the annular body is a sheet metal part.

10. The motor rotor of claim 1, wherein the annular body comprises non-magnetoconductive metal or plastic.

11. The motor rotor of claim 10, wherein the non-magnetoconductive metal is one selected from the group consisting of aluminum, copper, zinc, tantalum and stainless steel.

12. A motor, comprising:
a stator; and
a rotor surrounding an outer periphery of the stator, the rotor comprising:
an annular body;
a first positioning protrusion installed on an inner lateral surface of the annular body; and
a magnetic body installed on the inner lateral surface of the annular body and propping against the first positioning protrusion.

13. The motor of claim 12, wherein the first positioning protrusion has a first propping surface, and the magnetic body props against the first propping surface of the first positioning protrusion.

14. The motor of claim 12, wherein the first propping surface is planar.

15. The motor of claim 12, wherein first positioning protrusion is locked, riveted or adhered to the annular body or is formed by punching the annular body.

16. The motor of claim 12, further comprising a second positioning protrusion installed on the inner lateral surface of the annular body and having a second height different from a first height of the first positioning protrusion, wherein the magnetic body props against the first positioning protrusion and the second positioning protrusion.

17. The motor of claim 16, wherein the first positioning protrusion has a first propping surface, the second positioning protrusion has a second propping surface, and the magnetic body props against the first propping surface and the second propping surface.

18. The motor rotor of claim 17, wherein the first and second propping surfaces are planar.

19. The motor of claim 15, wherein the first and second positioning protrusions are locked, riveted or adhered to the annular body or are formed by punching the annular body.

20. The motor of claim 12, wherein the annular body is a sheet metal part.
